(19) United States
(12) Patent Application Publication
(10) Pub. No.: US 2024/0369275 A1
(43) Pub. Date: Nov. 7, 2024

(54) BLOCK PRESS FOR PRODUCING SOLID CARBON DIOXIDE

(71) Applicant: TOMCO2 SYSTEMS COMPANY, Loganville, GA (US)

(72) Inventor: HUGH SMITH, Rome, GA (US)

(21) Appl. No.: 18/656,235

(22) Filed: May 6, 2024

Related U.S. Application Data
(60) Provisional application No. 63/500,495, filed on May 5, 2023.

(51) Int. Cl. F25C 5/14

(52) U.S. Cl. CPC F25C 5/14

(57) ABSTRACT

The following generally relates to a system and method for dry ice production. In an aspect, a system for producing dry ice comprises a hydraulic power unit, a block press comprising, an injection point for receiving liquid carbon dioxide from a supply tank that includes a control valve, a chamber in fluid communication with the injection point and that receives the liquid carbon dioxide, the chamber at a lower pressure than the supply tank that allows the liquid carbon dioxide to undergo a flashing process that results in carbon dioxide snow and carbon dioxide gas, a hydraulic press powered by the hydraulic power unit that powers the hydraulic press to operate at variable speeds, the hydraulic press increasing pressure upon the carbon dioxide snow causing the carbon dioxide snow to form a solid carbon dioxide block, and an outlet for removing the solid carbon dioxide block.

### CROSS-REFERENCE TO RELATED APPLICATIONS

The present application claims priority from U.S. Provisional Patent Application No. 63/500,495, filed on May 5, 2023, the disclosure of which is hereby incorporated by reference in its entirety.

### BACKGROUND

Solid carbon dioxide (“CO₂”) or dry ice has many commercial uses. For example, shipping companies will often use dry ice to keep an environment cold as an item, such as food, is transported. In addition, dry ice is used to not only chill or freeze food, but also to carbonate drinks. In an industrial setting, dry ice blasting is used to clean certain surfaces. The entertainment industry has also used dry ice for effects such as fog.

Traditionally, dry ice equipment could only produce dry ice in the form of pellets. These pellets were useful for dry ice blasting or where small amounts of CO₂ were appropriate. Dry ice pellets could also be compressed together using a reformer to form larger CO₂ blocks, but these blocks may suffer from consistency or quality deficiencies and cost a large amount of CO₂ to properly form.

Larger presses also could be used to form a much larger dry ice block using a direct injection of liquid CO₂. Larger blocks of dry ice are typically manufactured in a standard, cubic size, which is often too large for purposes that require smaller blocks such as food refrigeration during transport. Therefore, larger blocks formed from this method would have to be cut using an industrial saw to fit a consumer's desired sizing. Using a saw to cut dry ice poses significant safety risks to the user and others that are nearby, and is inherently a less efficient process. Further, larger presses used to form large dry ice blocks also occupy a large amount of volume on an industrial floor.

It is with respect to these and other general considerations that embodiments have been described.

### SUMMARY

In accordance with the present disclosure, the above and other issues are addressed by the following:

In a first aspect, a system for producing dry ice comprises a hydraulic power unit, a block press comprising, an injection point for receiving liquid carbon dioxide from a supply tank that includes a control valve, a chamber in fluid communication with the injection point and that receives the liquid carbon dioxide, the chamber at a lower pressure than the supply tank that allows the liquid carbon dioxide to undergo a flashing process that results in carbon dioxide snow and carbon dioxide gas, a hydraulic press powered by the hydraulic power unit that powers the hydraulic press to operate at variable speeds, the hydraulic press increasing pressure upon the carbon dioxide snow causing the carbon dioxide snow to form a solid carbon dioxide block, and an outlet for removing the solid carbon dioxide block.

In a second aspect, a block press for producing dry ice blocks, comprises an injection point for directly receiving liquid carbon dioxide, the injection point including a control valve, a chamber in fluid communication with the injection point and that receives the liquid carbon dioxide, the chamber at a lower pressure than a liquid carbon dioxide supply line so the liquid carbon dioxide undergoes a flashing process that results in carbon dioxide snow and carbon dioxide gas as the liquid carbon dioxide enters the chamber, a hydraulic press that operates at variable speeds, and is operable to increase pressure upon the carbon dioxide snow causing the carbon dioxide snow to form a solid carbon dioxide block, and an outlet for removing the carbon dioxide block.

In a third aspect, a block press for producing dry ice blocks, comprising an injection point for directly receiving liquid carbon dioxide, the injection point including a control valve, a chamber in fluid communication with the injection point and that receives the liquid carbon dioxide, the chamber at a lower pressure than a liquid carbon dioxide supply line so the liquid carbon dioxide undergoes a flashing process that results in carbon dioxide snow and carbon dioxide gas as the liquid carbon dioxide enters the chamber, a hydraulic press that operates at variable speeds, and is operable to increase pressure upon the carbon dioxide snow causing the carbon dioxide snow to form a solid carbon dioxide block, and an outlet for removing the carbon dioxide block.

### BRIEF DESCRIPTION OF THE DRAWINGS

Non-limiting and non-exhaustive examples are described with reference to the following figures.

FIG. 1A illustrates an example perspective view CO₂ block press system.

FIG. 1B illustrates an example exploded view of the CO₂ block press system.

FIG. 2 illustrates an example perspective view of a CO₂ block press assembly.

FIG. 3A illustrates an example perspective view of a CO₂ block press with the gate closed.

FIG. 3A illustrates an example perspective view of a CO₂ block press with the gate opened.

FIG. 4 illustrates an example exploded view of the CO₂ block press of FIGS. 3A-3B.

FIG. 5 illustrates an example perspective view of a exhaust screen.

FIG. 6A illustrates an example cross-sectional view of a CO₂ block press in the retracted position.

FIG. 6B illustrates an example cross-sectional view of a CO₂ block press in the extended position.

FIG. 7 illustrates an example schematic view of a hydraulic power unit.

FIG. 8 illustrates an example view of the hydraulic and electrical connections for a CO₂ block press system.

FIG. 9 illustrates an example schematic view of the hydraulic connections for a CO₂ block press system.

FIG. 10 illustrates an example system for production of dry ice pellets using a CO₂ block press.

FIG. 11 illustrates an example view of a die that is used to produce dry ice pellets.

FIG. 12 illustrates an example method to produce dry ice blocks.

FIG. 13 illustrates an example method to produce dry ice pellets.

### DETAILED DESCRIPTION

Various embodiments will be described in detail with reference to the drawings. Reference to various embodiments does not limit the scope of the claims attached hereto. Additionally, any examples set forth in this specification are not intended to be limiting and merely set forth some of the many possible embodiments for the appended claims.

As briefly described above, embodiments of the present invention are directed to a block press (or referred to as a “press”) that uses direct injection of liquid CO₂ into a chamber of the press to produce solid carbon dioxide blocks. In some embodiments the press is connected to a hydraulic power unit (“HPU”) that is used to power a hydraulic press so it can operate at variable speeds and pressure for increased efficiency. Using a press with direct injection results in dry ice blocks that are of higher quality and better consistency so that less CO₂ is used to produce dry ice blocks. Also, the press's ability to produce smaller CO₂ blocks eliminates the need of needing to saw large dry ice blocks, which increases safety for dry ice producers.

In some embodiments, the block press uses a hydraulic press powered by a HPU to compress CO₂ snow that is formed within a cavity in the block press from direct liquid injection into a block. Once liquid CO₂ enters the press, it undergoes a flashing process that results in solid CO₂ in the form of snow that can then be compressed into a solid block. The HPU may also be a hybrid HPU that has less volume that a larger one, thus, conserving space on an industrial floor. By using an HPU in dry ice production, some benefits that may result are more dry ice production with less power consumption, lower CO₂ footprint, and quieter operation. In alternative embodiments, the HPU can be used in to produce dry ice pellets. In some examples, the HPU described in conjunction with the present disclosure provides constant pressure and speed throughout a piston stroke range, rather than varying depending on the distance of travel. Accordingly, the HPU control of the applied pressure to forcing CO₂ through a die can result in more consistent and dense solid CO₂ pellets. Other features and benefits of the present disclosure are reflected in the below embodiments.

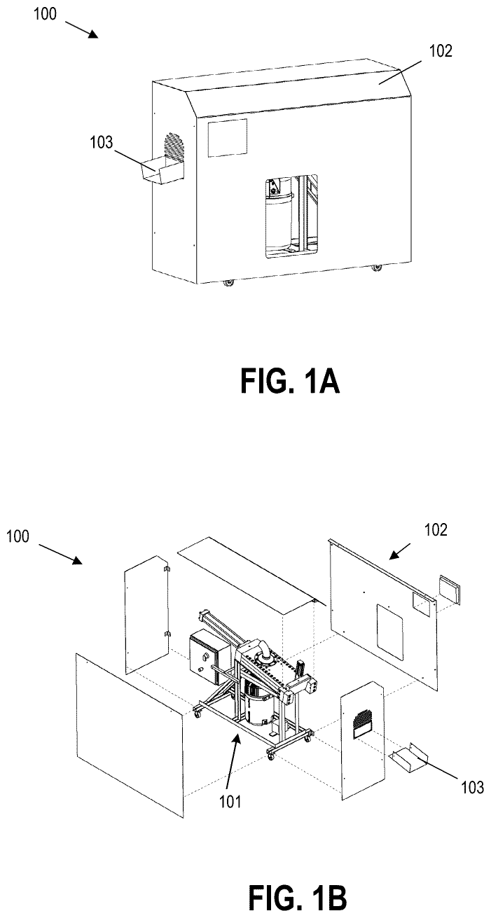

FIG. 1A illustrates an example perspective view block press system 100, and FIG. 1B illustrates an example exploded view of the block press system. Block press system 100 includes housing 102 and chute 103. The block press system 100 seen within FIG. 1A includes a housing 102 and chute 103, surrounding a block press assembly 101. In the example shown, the block press assembly 101 is configurable to produce dry ice blocks and dispense a solid CO₂ block via the chute 103. Housing 102 includes various access panels and/or openings to access or replace various components such as the HPU, liquid CO₂ tank, or other components discussed below. In other embodiments, housing 102 includes an interface for configuring/programming block press system 100 to produce dry ice blocks such as an electrical interface or valves to control the flow of fluids.

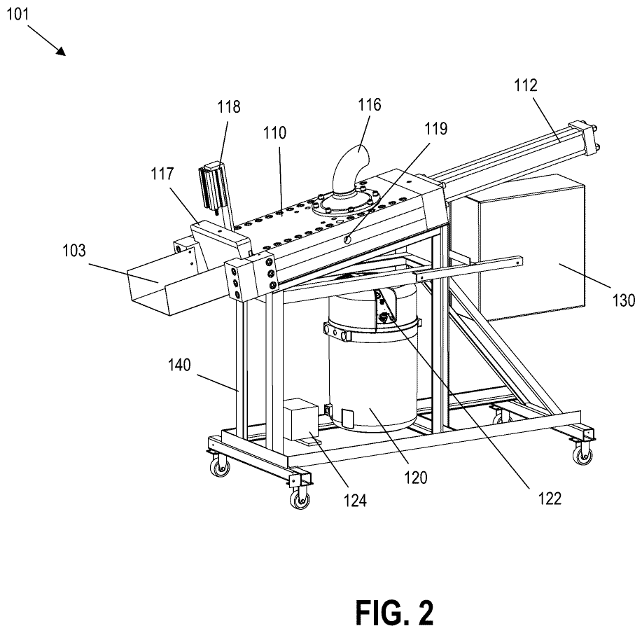

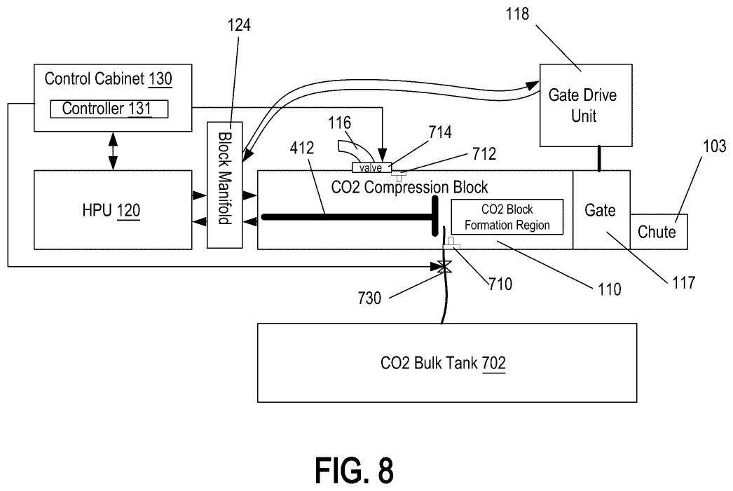

FIG. 2 illustrates an example interior view of a block press system 100, e.g., showing a block press assembly 101 with the housing 102 removed. As shown, block press assembly 101 includes block press 110 that is connected to a hydraulic power unit (HPU) 120. The HPU 120 imparts force to power the hydraulics of the system. HPU 120 and liquid injection of CO₂ can be controlled by a controller 131 (seen schematically in FIG. 8) within control cabinet 130. As illustrated, the block press 110, HPU 120, and control cabinet 130 may all be mounted on support 140.

In the example shown, block press 110 further includes hydraulic press 112 to compress solid CO₂ to produce dry ice blocks and chute 103 where the produced dry ice block is retrieved. Hydraulic gate drive 118 is also powered by HPU 120, thereby allowing for selective opening and closing of a gate across an opening of chute 103. The gate drive 118 may cause the gate to be closed during compression, and to open after the block is formed, allowing the hydraulic press to further press the block toward the chute 103, as discussed further below. To connect both hydraulic presses, HPU 120 connects to block manifold 124 that contains directional valves to direct hydraulic fluid to either or both of hydraulic press 112 and gate drive 118. Exhaust 116 allows for any exhaust formed during the flashing process to exit block press 110 in any selected interval. HPU 120 further includes HPU electrical interface 122 that can control HPU 120 through a connection to control cabinet 130.

In the embodiment shown, block press 110 is configurable to receive liquid carbon dioxide through liquid CO₂ inlet/port 119. Liquid carbon dioxide is stored at a source, which may be a tank, cither local to the block press 110 or positioned remotely therefrom and connected by supply lines. The liquid flows from the source to block press assembly 101. As the CO₂ enters an interior chamber of the block press 110 as a liquid, it undergoes a flashing process due to a change of pressure from a high pressure environment to atmospheric conditions, thus, creating CO₂ snow and vapor as exhaust. CO₂ snow forms from the sudden drop in temperature due to the rapid expansion and change of state of the gaseous form of CO₂, and gases formed exit the exhaust 116. As the snow forms, hydraulic press 112 compresses the fresh snow into a block of dry ice. If more snow is needed, hydraulic press 112 can retract and more liquid can be injected through inlet 119. This may occur one or more times; in other words, a first pressing action may compress snow toward the gate 117, and then a hydraulic piston may retract to enable introduction of additional CO₂ into an interior chamber of the block press 110 iteratively until a desired depth (e.g., length of the block press 110 in a direction facing the gate 117) is reached, at which time the block may be ejected as discussed below. In other examples, only a single block formation iteration may be required.

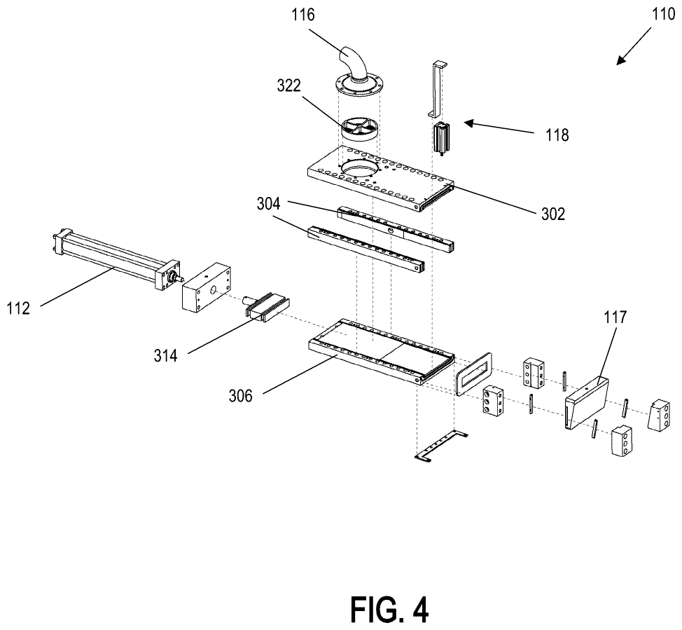

Traditional systems produce blocks with dimensions 10″×10″×10″, while in some example embodiments described herein, the block press 110 will produce dry ice blocks with dimensions 10″×10″×2″. In other embodiments, block press system 101 will produce dry ice blocks with dimensions 10″×5″×2″ or other similar reduced-size blocks that do not require cutting for desired applications, which improves overall efficiency. Still further, other reduced-dimension blocks may be generated using structurally-similar systems in a manner consistent with the present disclosure. In a particular example, block press system 101 produces blocks of selectable, varying dimensions. To achieve different sizes for blocks, block press 110 may include interchangeable plates. These plates can be used to change out various sides of the interior volume of the block press 110 to create different sizes, as discussed in connection with FIG. 4.

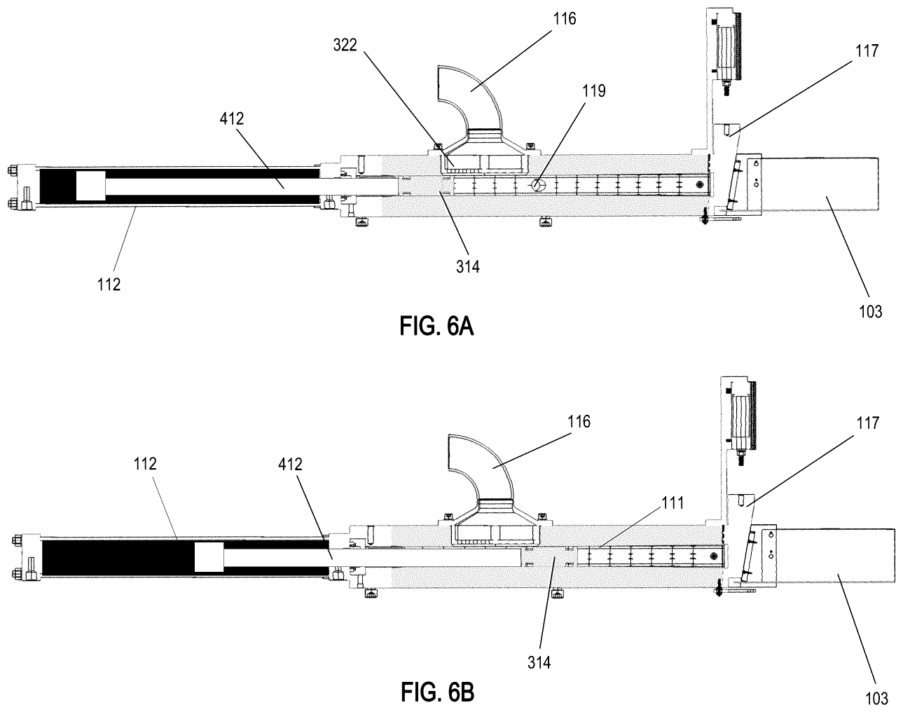

Further, in the embodiment shown, block press 110 includes hydraulic press 112. Hydraulic press 112 includes a hydraulic fluid connection with HPU 120 through block manifold 124. This fluid connection allows for hydraulic fluid to flow between hydraulic press 112 and HPU 120 as pressure is applied to hydraulic press 112. As pressure increases a cylinder within hydraulic press 112 begins to move through the chamber of block press 110, from a retracted position away from the chute 103 to an extended position toward the chute 103. The hydraulic press 112 may be operated while introducing CO₂ into the interior volume of the block press 110 to compress any snow formed within, as explained in conjunction with FIGS. 6A-6B.

In the example shown, gate drive 118 may also be connected to HPU 120 through a hydraulic connection to block manifold 124, and is hydraulically-actuated to press the gate 117 downward into the closed position or retract upward to move the gate to an open position when desired. In alternative embodiments, the gate driver 118 may be implemented as an electric motor operating a screw-drive to raise and/or lower the gate as necessary. Other actuation mechanisms may be used as well, in various alternative embodiments.

The shown embodiment further includes exhaust 116 attached to block press 110. This exhaust allows extraneous gas produced during the flashing process to escape the interior volume of the block press 110. Exhaust 116 can take other designs in other embodiments; in some examples, including a larger arrangement (e.g., 10″×5″×2″ block press) in which two or more exhausts may be included. Furthermore, although exhaust 116 is placed on a top of the block press 110, it may be located on any side convenient to exhaust gas. As discussed below, in some implementations, exhaust 116 is configurable to actuate a valve to control the amount of exhaust that is released.

In the example shown, and as previously discussed, block press 110 also includes chute 103. The chute 103 is sized to receive a block output when gate 117 is opened and hydraulic press 112 extends to push the formed CO₂ block out of the block press 110. The chute 103 may be configured to allow the block to slide away from the gate, and/or to retain the block for retrieval by an operator. As discussed further below, in some instances, the chute 103 may be configure to receive not only blocks, but pellets formed using the block press 110. As with blocks, the chute may either retain pellets or allow them to slide/fall away from the gate and toward a receptacle that may be placed at an end of the chute 103.

As discussed, HPU 120 is used to power the hydraulics of block press system 100 such as hydraulic press 112 and gate drive 118. In some embodiments HPU 120 is a hybrid HPU, such as a Rexroth CytroPac RE 51055. In general, the HPU 120 cooperates with the hydraulic press 112 to provide a near constant speed, constant pressure force via the hydraulic press 112, thereby improving the quality of blocks created. Specifically, through use of constant speed, a more uniform block with fewer weakened areas, and therefore less apt to crack or break, may be formed.

In the example embodiment shown, HPU 120 includes electrical interface 122 Electrical interface 122 allows for various electrical based connections between the HPU and other devices, such as a controller within control cabinet 130 that enables a user to manually operate, or programmatically operate through use of a programmable logic controller unit (PLC), the HPU. For example, electrical interface 122 may include a feed in/voltage supply, a 24 V interface, a mini-USB service interface, an STO interface, and a multi-ethernet interface for network input and output. Some of these features may not be included in some embodiments, while additional connection types are included in others. In some embodiments, HPU 120 provides more benefits in CO₂ production. For example, using HPU 120 as opposed to a convention hydraulic system can result in energy savings of 890 kWh/a and CO₂ savings of 0.48 ton/a. Other costs savings may be realized as well by using HPU 120.

In the discussed and shown embodiment, the HPU 120 hydraulically connects to hydraulic press 112 through block manifold 124, e.g., it is fluidically connected through the block manifold 124 and various hydraulic conduits to enable hydraulic fluid flows between the HPU 120 and hydraulic press 112 as HPU 120 changes the applied pressure upon the hydraulic fluid. As noted above, HPU 120 is operable to power hydraulic press 112 so that it operates in a manner that allows a user to better control the speed and pressure of hydraulic press 112. For example, if hydraulic press 112 must be retracted, HPU 120 can retract at a faster speed then if it was compressing snow. Further embodiments, HPU 120 allows hydraulic press 112 to maintain a constant pressure as more snow is compressed into a block, thereby maintaining uniformity through the block depth. In other embodiments, HPU 120 can maintain a constant pressure as more solid CO₂ is pushed through a die. It is noted that in other hydraulic press implementations, gain or loss of pressure is common as snow forms and is pushed forward in the hydraulic press 110. Further details of operation of the HPU in these contexts are discussed below in connection with FIGS. 8-13.

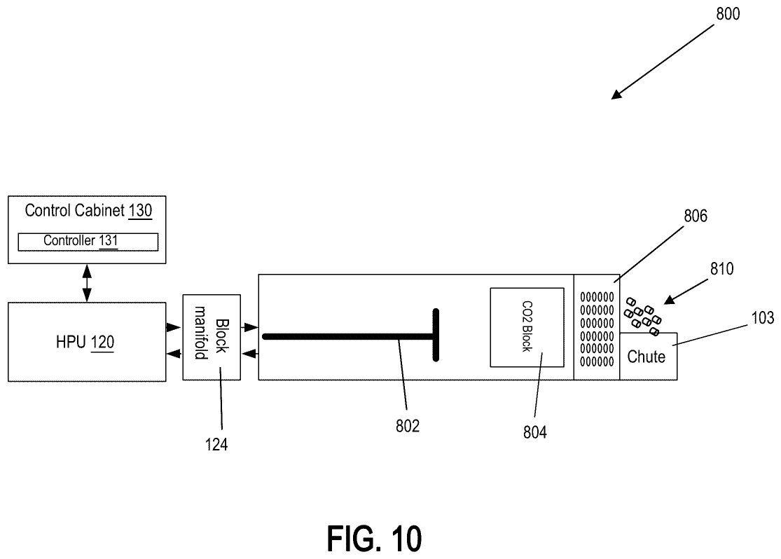

In the embodiment shown, block press 100 further includes control cabinet 130 that includes controller 131, shown schematically in FIGS. 8 and 10. Control cabinet 130 includes components, such as controller 131 to control electrical power to block press system 100, as well as various other electrical components (e.g., a power supply, communication interface, and the like, which are not shown for simplicity). In example implementations, the controller 131 may be configured to control the HPU 120 to ensure the proper amount of pressure is applied. Control cabinet 130 also can control the amount of liquid CO₂ is injected into block press 110 through the actuation of one or more valves, including an inlet valve. Control cabinet 130 further controls valves that are connected to exhaust 116 to control venting. In the shown embodiment, control cabinet 130 operates HPU 120 to control gate 117 through gate driver 118 that covers chute 103. The system may also include other electrical features in other embodiments that control cabinet 130 manages and/or maintains. For example, control cabinet 130 may have a safety button that shuts down the system in case of an emergency. Further, controller 131 within control cabinet 130 may include a microcontroller or microprocessor that can be programmed to configure all the previously mentioned controls. In other embodiments, controller 131 includes a programmable logic controller (“PLC”) that is configured to administer the above features. Different types of PLCs that can be used include modular PLCs, compact PLCs, and integrated PLCs.

As previously mentioned, the illustrated embodiment of block press system 100 also includes support 140. Support 140 includes wheels, however, it may be attached to the ground in some embodiments. In other embodiments, support 140 has a different type of moving means for repositioning block press system 100. Support 140 may also take different shapes and include other supports attached to it for other equipment not shown.

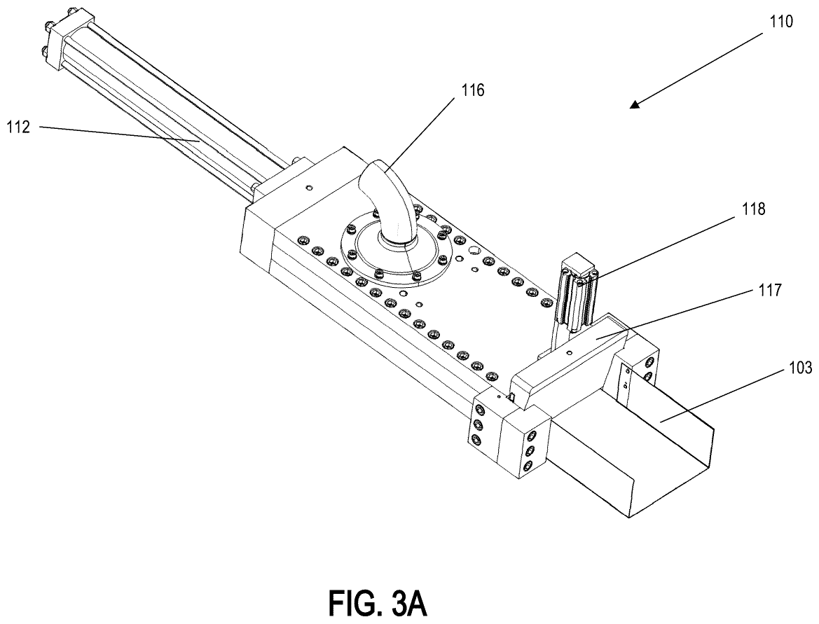

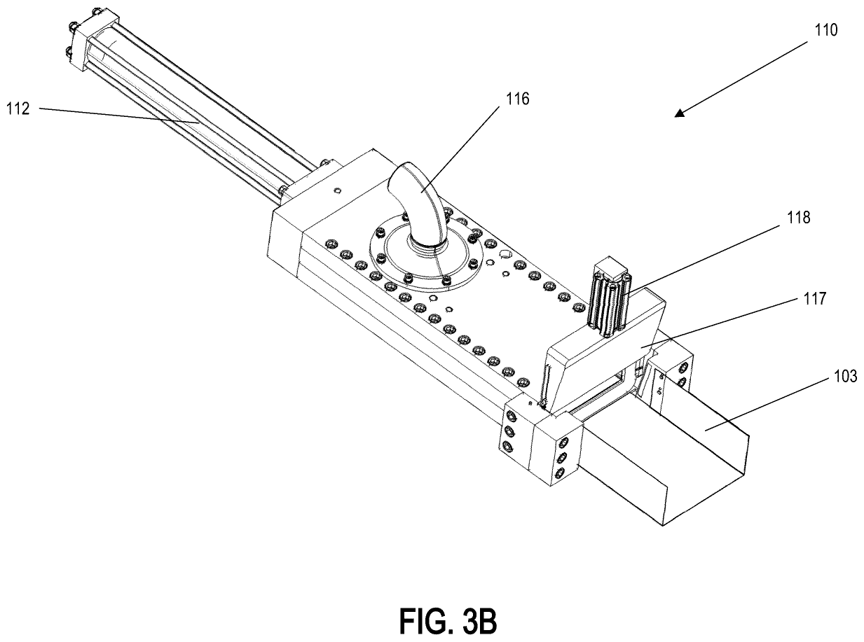

FIGS. 3A and 3B illustrate example perspective views of block press 110. In FIG. 3A, block press is shown with gate 117 closed. Gate 117 may be closed during compression of snow within the chamber of block press 110. Gate 117 remains closed through a limit switch within the hydraulic fluid connection of gate drive 118, block manifold 124, and HPU 120. The limit switch will isolate this hydraulic fluid circuit so that gate 117 is retained in a closed position. Through this isolation, pressure does not need to be maintained by gate drive 118 to keep gate 117 closed while snow is compressed.

FIG. 3B shows block press 110 with gate 117 raised using gate drive 118 (e.g., by retracting a piston actuated by the gate drive 118. Alternatively, gate drive 118 may raise and/or lower the gate using a mechanical screw driver or other mechanical mechanism, rather than a hydraulic mechanism; in such instances, operation of the gate drive 118 may be controlled and synchronized with operation of the hydraulic press 112 by the controller 131. As the gate opens, the cylinder within hydraulic press 112 can extend further to push the newly formed block from the chamber within block press 110 into chute 103.

Although the gate drive 118 is depicted “above” the gate 117 in the example shown, in alternative embodiments, the gate drive 118 may be positioned below the chute 113 and may either push the gate 117 upward by extending a hydraulic piston or pair of pistons along sides of the gate, or otherwise actuate the gate between open and closed positions.

FIG. 4 illustrates an example exploded view of block press 110. The exploded view of block press 110 shows hydraulic press 112, exhaust 116, gate drive 118, gate 117, as well as top plate 302, side plates 304, and bottom plate 306.

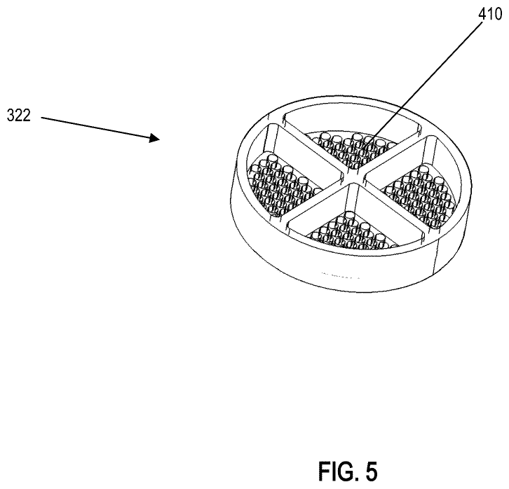

In the example embodiment shown, the exhaust 116 includes a screen 322. The screen 322, seen best in FIG. 5, provides improved vending of excess CO₂ from the system during and/or after flashing. In particular, the screen 322 reduces the extent to which snow escapes an interior of the block press 110 through exhaust 116. The extent to which snow might escape via the exhaust 116 may depend on factors such as the amount of injected liquid CO₂ and speed of compression via the hydraulic press. In the embodiment shown in FIG. 5, the screen 322 includes filter 410, which has openings small enough to allow CO₂ gas to escape but prevent snow from exiting through exhaust 116. Many different shaped openings can be used for filter 410. The example shown is intended as illustrative rather than limiting.

Referring back to FIG. 4, in the illustrated embodiment, plates 302, 304, and 306 can join together to form a chamber 111 (shown in FIGS. 6A-6B) that houses snow to be compressed into a solid block of CO₂. In some embodiments, some or all of these plates can be interchanged, or moved, to create different sized blocks. For example, the plates 302, 304, 306 may be adjusted, or may hold a mold therebetween, that defines a shape of a block. In example implementations, the plates 302, 304, 306 form a generally rectangular or cuboid shape. In some implementations, however, the shape may have slightly increasing cross-sectional size in a direction toward the gate 117. For example,

In example implementations, hydraulic press 112 can also include various components that effectuate compression upon the CO₂, such as a piston cylinder shown in FIGS. 6A and 6B, and compression block 314. The compression block 314 is generally sized and shaped complementarily to the positions of plates 302, 304, 306, to enable pressing of snow toward the gate 117. In examples where the cross-sectional size of the chamber 111 increases in a direction toward the gate 117, the compression block 314 is sized to enable compression throughout the range, while minimizing any gaps around the block when it is positioned in the extended position. In some implementations, the chamber 111 is only arranged with increasing size in a region proximate the gate and along a length of the chamber that corresponds to the desired length of the created CO₂ block.

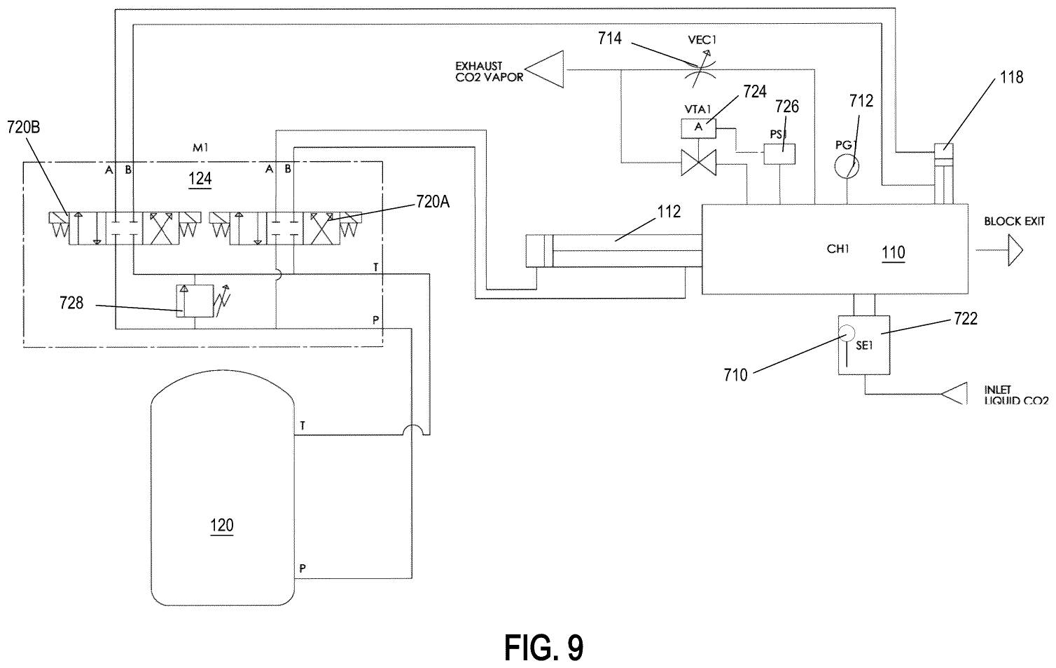

To better vent excess CO₂ from the system after flashing, screen 322 is installed with exhaust 116. Although not shown in FIG. 4, exhaust 116 and screen 322 may include a valve to control venting of the CO₂ exhaust (seen schematically in FIG. 9 as valve 714). Exhaust 116 is also connected to a mold in top plate 302. However, plates 304 and 306 can be adjusted in size and position to allow for moving exhaust 116 to a different plate or adding additional exhaust ports constructed in a similar way. Other components may be included as well such as valves, pressure sensors, and temperature sensors.

FIGS. 6A and 6B illustrate schematic cross-sectional views of block press 110. In FIG. 6A, a cylinder 412 is in a retracted position. The cylinder 412 may be included as part of the hydraulic press 112. In this position, liquid CO₂ is injected through inlet 119, which will undergo the flashing process previously described to become part CO₂ snow and part CO₂ gas. The CO₂ gas is then vented out through exhaust 116. Gate 117 is maintained in the closed position so snow does not escape during the flashing process and during compression. Further, cylinder 412 and compression block 412 are attached so as to synchronously move as a unit.

In FIG. 6B cylinder 412 and compression block 314 have moved into an extended, or compressing, position. Here, snow that is present within the chamber 111 of block press 110 is compressed into a block. The cylinder 412 and compression block 314 position can also be monitored from HPU 120 by monitoring the applied hydraulic pressure. Using HPU 120 to monitor position, a user can dynamically monitor the size of a dry ice block for each cycle of compression by cylinder 412 and compression block 314. Monitoring position allows a user to determine if a dry ice block is the correct dimensions. Accordingly, the user may be able to control the HPU, causing the hydraulic press 112 to move toward the retracted position shown in FIG. 6A, and inject more liquid CO₂ through inlet 119 if the block is too small. Further, cylinder 412 and compression block 314 can be extended further (e.g., beyond the point at which block size is desired) when gate 117 is opened, for example to push out the dry ice block into chute 103.

In example implementations, the HPU 120 is also operable to retract and extend the cylinder 412 and compression block 314 at different speeds. For example, if no snow is present within the chamber 111 other than close to gate 117, cylinder 412 and compression block 314 can move through the chamber of the block press 110 at greater speeds for at least a portion of time, e.g., until it reaches the snow. At that time, the speed may be decreased and a constant pressing operation may be applied. This preserves the constant pressure applied to the block while decreasing the overall time needed to produce a block. In addition, cylinder 412 and compression block 314 can be retracted at greater speeds than used when compressing snow, thereby obtaining the same time benefit. In the shown embodiment, cylinder 412 and compression block 314 may extend at a slower speed while compressing due to the mass of the snow being compressed at the end of the chamber opposite of hydraulic press 112.

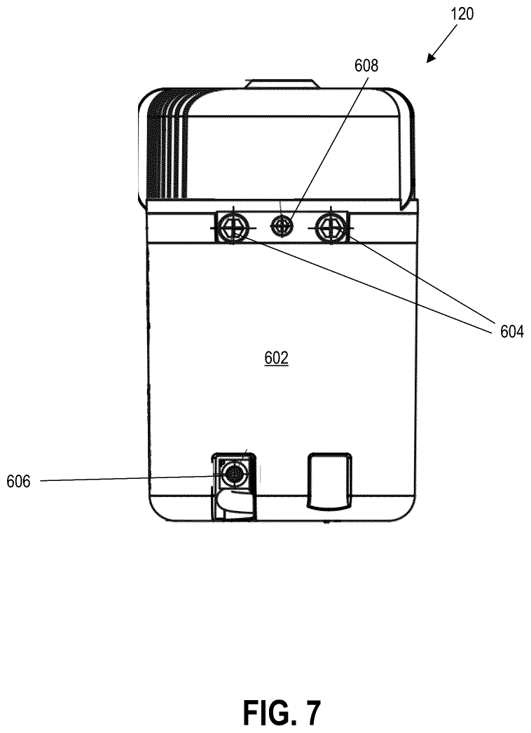

FIG. 7 illustrates an example hydraulic power unit (HPU) 120. In this embodiment, HPU 120 connects to hydraulic presses/equipment through hydraulic connections 604 and pressure port 606 that lead to hydraulic tank 602 within HPU 120. Further, pressure port 508 provides a connection that can be used to supply a pressurized fluid to a hydraulic system or allow for monitoring the pressure of HPU 120. When in use with block press 110 in system 100, one of hydraulic connections will fluidically connect, e.g., connect through a hydraulic fluid line so that hydraulic fluid can flow according to a pressure differential, and then have a separate connection that returns to return connection 608. As shown in FIG. 7B, HPU will connect to block manifold 124 that then directs the hydraulic fluid to either hydraulic press 112 or gate drive 118.

Although not shown, HPU 120 includes in some embodiments a central plate, pump, motor, filters, contamination sensors, temperature sensors, frequency converter, pressure load cell, check valve and a filling coupling. These components can be configured to operate the hydraulic press and produce solid CO₂ blocks. In some embodiments pressure produced by HPU 120 can reach 2000 psi and a flow rate of 5 gal/min. HPU 120 may also average power consumption at 0.92 hp. Further features of the HPU may include the ability to control the speed of the hydraulic press as it is retracted or pushed to a starting compression point. Traditional systems often only operate at a constant speed during these phases, and HPU 120 can change speed, thus, decreasing the amount of time required to produce blocks.

FIG. 8 illustrates, schematically, the overall block press system 100 as described herein, including compression block 110, chute 103, gate drive unit 118, hydraulic cylinder 412, block manifold 124, HPU 120, and control cabinet 130 and controller 131. In this example, a bulk tank 702 is depicted as providing liquid carbon dioxide to the compression block 110. In this example, pressure sensors 710 and 712 are depicted, which determine a pressure of received liquid carbon dioxide and a chamber pressure within the compression block 110, respectively. Additionally, a valve 715 selectively enables opening of exhaust 116. A further valve 730 may be actuated to supply liquid carbon dioxide to the chamber 111.

Although not shown in FIG. 8, in some example embodiments, the exhaust may route to one or more additional pieces of equipment that may be used in block or pellet creation. For example, because the exhaust is significantly cooled, it may be routed to a heat exchanger that is positioned along the liquid line between the bulk tank 702 and the compression block 110. Because the exhaust is in gas form but significantly colder than the liquid carbon dioxide provided into the compression block (e.g., usually up to or exceeding 50 degrees colder), it may assist in providing some additional cooling of the liquid prior to injection into the compression block.

FIG. 9 illustrates an example further detailed schematic view of the connections for a CO₂ block press system. HPU 120 will connect to block manifold 124 that includes directional valves 720A, 720B and pressure regulator/limiter 728. Directional valves 720A, 720B can direct incoming hydraulic fluid to either hydraulic press 112 through directional valve 720A and to gate drive 118 through directional valve 720B. Further, the return line from both hydraulic press 112 and gate drive 118 is illustrated as combined back into one return line that connects to return connection 608 of HPU 120. In addition, pressure sensor 710 is able to detect the incoming pressure of the liquid CO₂ supply line and transmit the temperature data to controller 131 that may be displayed on an interface not shown here. Chamber pressure sensor 712 also detects the pressure within the chamber of block press 110, which in this embodiment is approximately 60 psi, although different pressures may be used.

In example embodiments, control cabinet 130 and controller 131 connect to and actuate valve 730 that controls injection of liquid CO₂ into the chamber of block press 110. Valve 730 connects to the liquid CO₂ supply line that connects to CO₂ bulk tank 702 that stores liquid carbon dioxide at a specific pressure, such as 300 psi. Controller 131 further actuates valve 714 to control the internal pressure within block press 110. If opened, CO₂ gas travels through exhaust 116 to the outside atmosphere and lowers the pressure within the chamber of block press 110.

FIG. 9 also shows details regarding inlet port 119 and exhaust 116. Regarding inlet port 119, the block press system 100 includes self exhausting injection horn 722 useable to inject CO₂ into port 119, alongside the pressure sensor 710 described above. Although not shown, temperature sensors also may be included to monitor the temperature within block press 110 or the liquid CO₂ before it enters block press 110. Regarding the exhaust 116, that portion is illustrated as including a vent to atmosphere valve 724, as well as a chamber pressure switch 726.

FIG. 10 illustrates an example dry ice pellet production system or pelletizer arrangement using similar structures to those described above. Pellet production system 800 is generally similar to the system for creating blocks shown in FIG. 8, but may be programmed and structured slightly differently. In particular, control cabinet 130 contains controller 131 is operable to control HPU 120 that connects through block manifold 124 to hydraulic cylinder 802. However, in this instance, the controller 113 controls the HPU 120 to hydraulically power hydraulic cylinder 802 to compress a CO₂ block 804 positioned within the chamber 111 into die 806. As block 804 is compressed into die 806, pellets 810 are extruded from die 806 into chute 103.

In this alternative embodiment, control cabinet 130, controller 131, HPU 120, and block manifold 124 are the same as previously described with possible minor changes to operate as shown. Hydraulic cylinder 802 is powered through a hydraulic fluid circuit that connects to HPU 120 through block manifold 124. Block manifold may be omitted in different embodiments since a second cylinder, such as gate drive 118, is not included. Hydraulic cylinder may also be similar to hydraulic press 112 but with modifications to press a solid CO₂ block instead of snow. Further, HPU 120 allows for better control of the hydraulic press 112. For example, HPU 120 will adjust the pressure as more of CO₂ block is forced through die 806. Since less of CO₂ block is present, less pressure is needed to force the remaining amount through the die at the same speed. Adjusting the pressure of hydraulic cylinder 802 to maintain a constant speed allows for more consistent and better quality pellets 810 as opposed to maintaining a constant pressure that causes the extruding process to speed up and resulting in less dense and less consistent pellets 810. Pellets 810 may also be strands of dry ice as well.

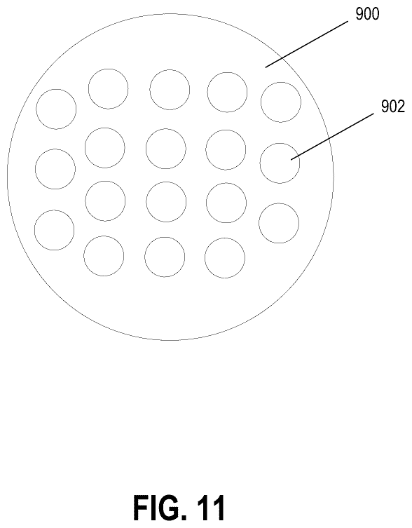

FIG. 11 illustrates an example die 900 that is used to produce dry ice pellets. Die 900 is a representative schematic depiction of die 806 of FIG. 10, and includes openings 902 that allow dry ice to pass through as a block is compressed against it, thus, creating pellets or strands in the illustrated embodiment. In this example, a round die is illustrated, whereas the die 806 may be rectangular. Still further, different size or shaped openings can be used as well. The die may be of varying diameters and/or dimensions, with different opening sizes corresponding to sizes or shapes of desired pellets to be created.

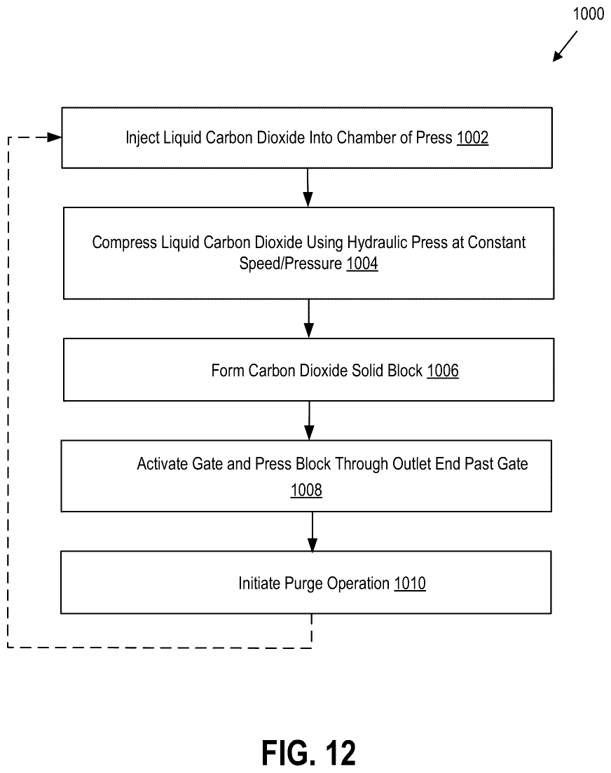

FIG. 12 illustrates an example method to produce dry ice blocks. In this embodiment, method 1000 includes operations 1002-1008 may be accomplished using some or all of the embodiments discussed previously in FIGS. 1-9, above.

At operation 1002, a block press system such as block press system 100 will complete the feature of injecting liquid carbon dioxide from a supply line through a control valve into a chamber of a block press at a lower pressure than the supply line. This results in the supplied liquid carbon dioxide quickly cooling due to expansion, resulting in formation of CO₂ snow and vapor (gas). Accordingly, at operation 1004, the feature of flashing the liquid carbon dioxide that results in carbon dioxide snow and carbon dioxide gas is accomplished.

At operation 1006, a hydraulic press, such as press 112 and associated HPU 120, as controlled by controller 131, compresses the snow into a carbon dioxide block. This may be performed by monitoring the rate of dry ice formation, the position of the hydraulic press, internal pressure within the chamber of block press 110, and the like. As noted above, one or more actuations forward of the hydraulic press 112 may be performed until a block of desired size is formed.

At operation 1008, the system will output a solid carbon dioxide block through an outlet of the carbon dioxide press. This outlet, in some embodiments, is chute 103. To do so, the gate drive 118 may by actuated by the HPU 120 (e.g., by a controller 131 controlling manifold 124), to actuate the gate 117 to an open position. Additionally, the controller 131 may cause additional pressure to be applied by hydraulic press 112, causing a block to exit the chamber 111 through an opening formed when the gate 117 is moved to the open position, thereby depositing the block at the chute.

Method 1000 may further comprise of the steps dynamically monitoring the size of the carbon dioxide block by monitoring the position of the hydraulic press within the chamber of the block press and injecting more liquid carbon dioxide in response to the carbon dioxide block having incorrect dimensions.

In example embodiments, the method 1000 further includes operation 1010, which includes initiating a purge operation of the block press 110. The purge operation involves introducing warmed gas into the chamber while the hydraulic press 112 and gate 117 are moved to the retracted and closed positions, respectively. The introduction of warm gas into the chamber 111 removes remaining frost, liquid carbon dioxide, or other remnants that may be present in the chamber. This prevents moisture build up in the event the system is used repeatedly for creation of a number of blocks. In example embodiments, a vapor line extending from a CO₂ bulk tank may provide a source of warm gas that may be used, optionally after being passed through a separate CO₂ heater. This enables heating of vapor to a temperature in the range of 40-50 degrees Fahrenheit, which is sufficient to purge moisture without significantly heating the walls or other physical features of the chamber.

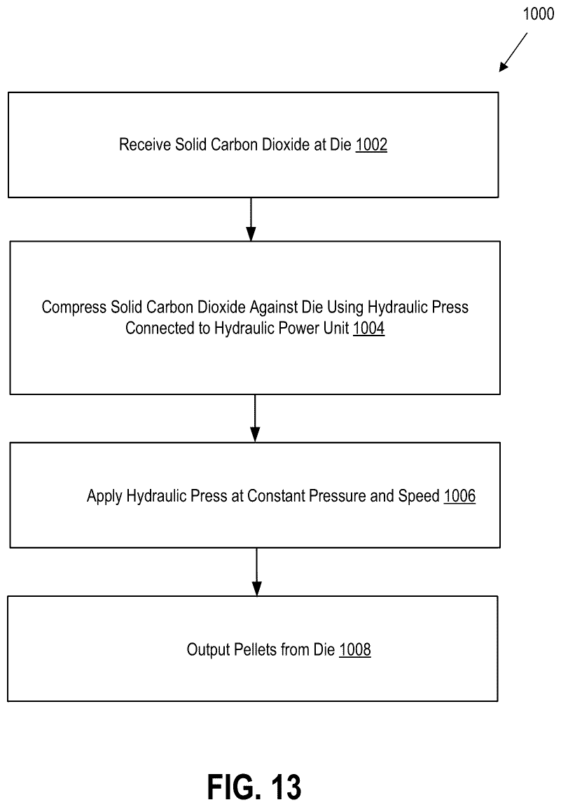

FIG. 13 illustrates an example method to produce dry ice pellets. Method 1100 includes operations 1102-1108 in this embodiment and may be accomplished using some or all of the embodiments discussed previously in FIGS. 1-11.

At operation 1102, solid carbon dioxide is received at a die. The die may be die 806, die 900, or any other suitable die to create pellets of a desired size and shape . . . .

At operation 1104, the step of compressing the solid dry ice against the die using a hydraulic press connected to a hydraulic power unit is accomplished. The hydraulic press and hydraulic power unit may be press 802 and HPU 120 respectively.

At operation 1106, the step of maintaining a constant pressure and speed while compressing the solid dry ice against the die is accomplished. HPU 120 provides the ability to maintain the hydraulic press speed even as there is less ice. This feature may be accomplished, for example, by selectively lowering the pressure upon the block depending on how much ice is left since less ice will require less pressure to be pushed through die 806.

At operation 1108, solid carbon dioxide pellets are output from the die into tray 103. Dry ice pellets can then be used for various purposes such as dry ice blasting or mixing in food.

In example implementations the process for producing dry ice pellets may also utilize the purge operation described above in conjunction with operation 1010 of FIG. 12. Such an operation may be selected if a large number of pellets are desired to be formed, and a large number of blocks of carbon dioxide are to be sequentially pressed to form such pellets.

The present disclosure is not to be limited in terms of the particular embodiments described in this application, which are intended as illustrations of various aspects. Many modifications and variations can be made without departing from its spirit and scope. Functionally equivalent methods and systems within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only, and is not intended to be limiting.

The above specification, examples and data provide a complete description of the use of the invention. Since many embodiments of the invention can be made without departing from the spirit and scope of the invention, the invention resides in the claims hereinafter appended.

What is claimed is:

1. A system for producing dry ice, the system comprising:
a hydraulic power unit;
a block press comprising;
an injection point for receiving liquid carbon dioxide from a supply tank that includes a control valve;
a chamber in fluid communication with the injection point and that receives the liquid carbon dioxide, the chamber at a lower pressure than the supply tank that allows the liquid carbon dioxide to undergo a flashing process that results in carbon dioxide snow and carbon dioxide gas;
a hydraulic press powered by the hydraulic power unit that powers the hydraulic press to operate at variable speeds, the hydraulic press increasing pressure upon the carbon dioxide snow causing the carbon dioxide snow to form a solid carbon dioxide block; and
an outlet for removing the solid carbon dioxide block.

2. The system of claim 1, wherein the block press further comprises an exhaust port for venting the carbon dioxide gas.

3. The system of claim 2, wherein the exhaust includes a valve to control the amount of carbon dioxide gas that exits the system to control the pressure within the chamber.

4. The system of claim 1, wherein the block is 10″×10″×5″ or 10″×5″×2″.

5. The system of claim 1, further comprising a control unit that controls the amount liquid carbon dioxide injected into the chamber by actuating the control valve.

6. The system of claim 1, wherein the block press further includes interchangeable plates that are configurable to change the volume of the solid carbon dioxide block.

7. The system of claim 1, further comprising:
a gate that covers an opening of the block press;
a hydraulic gate drive that opens and closes the gate; and
a block manifold that connects the hydraulic connection of the HPU to hydraulic press and the hydraulic gate.

8. The system of claim 7, wherein the block manifold includes directional valves to direct the flow of hydraulic fluid from the HPU to the hydraulic press and the hydraulic gate and return the hydraulic fluid back to the HPU.

9. A block press for producing dry ice blocks, the block press comprising:
an injection point for directly receiving liquid carbon dioxide, the injection point including a control valve;
a chamber in fluid communication with the injection point and that receives the liquid carbon dioxide, the chamber at a lower pressure than a liquid carbon dioxide supply line so the liquid carbon dioxide undergoes a flashing process that results in carbon dioxide snow and carbon dioxide gas as the liquid carbon dioxide enters the chamber;
a hydraulic press that operates at variable speeds, and is operable to increase pressure upon the carbon dioxide snow causing the carbon dioxide snow to form a solid carbon dioxide block; and
an outlet for removing the carbon dioxide block.

10. The block press of claim 9, wherein the block press further comprises an exhaust port for venting the carbon dioxide gas.

11. The block press of claim 10, wherein the exhaust includes a valve to control the amount of carbon dioxide gas that exits the system to control the pressure within the chamber.

12. The block press of claim 11, wherein the exhaust includes a screen that prevents carbon dioxide snow from

13. The block press of claim 9, wherein the block is 10″×10″×5″ or 10″×5″×2″.

14. The block press of claim 8, further comprising a control unit that controls the amount liquid carbon dioxide injected into the chamber by actuating the control valve.

15. The block press of claim 9, further comprising interchangeable plates that are configurable to change the volume of the carbon dioxide block.

16. The block press of claim 9, further comprising:
a gate that covers an opening of the block press; and
a hydraulic gate drive that opens and closes the gate.

17. The block press of claim 9, wherein the hydraulic press is configurable to connect to a HPU.

18. A method for producing dry ice blocks, the method comprising:
injecting liquid carbon dioxide from a supply line through a control valve into a chamber of a block press at a lower pressure than the supply line;
flashing the liquid carbon dioxide that results in carbon dioxide snow and carbon dioxide gas;
compressing, by a hydraulic press, the snow into a carbon dioxide block; and
outputting the carbon dioxide block through an outlet of the block press.

19. The method of claim 18, the method further comprising dynamically monitoring the size of the carbon dioxide block by monitoring the position of the hydraulic press within the chamber of the block press.

20. The method of claim 19, further comprising injecting more liquid carbon dioxide in response to the carbon dioxide block having incorrect dimensions based on the dynamic monitoring.
